(19) United States
(12) Patent Application Publication
(10) Pub. No.: US 2025/0207458 A1
(43) Pub. Date: Jun. 26, 2025

(54) Flood Water Gate Barrier

(71) Applicant: Vitaliy Kravchenko, Largo, FL (US)

(72) Inventor: Vitaliy Kravchenko, Largo, FL (US)

(21) Appl. No.: 18/989,097

(22) Filed: Dec. 20, 2024

Related U.S. Application Data
(60) Provisional application No. 63/612,965, filed on Dec. 20, 2023.

(51) Int. Cl. E06B 9/00

(52) U.S. Cl. CPC E06B 9/00; E06B 2009/007

(57) ABSTRACT

An adjustable flood-resistant barrier for removable installation in a window or door is provided. A vertically adjustable anchor mounts to the opening frame using a jacking system. One or more flood gates having water impermeable panels attach to the anchors, and can be laterally expanded to engage a silicone seal with the sides and bottom of the opening. An improved peripheral seal minimizes the likelihood of leakage at the corners. For wide openings, multiple flood gates can be assembled adjacent to each other.

### CROSS REFERENCE TO RELATED APPLICATIONS

This application claims priority to U.S. Provisional Patent Application 63/612,965, entitled, “Flood Water Barrier Gate”, filed Dec. 20, 2023, the contents of which are herein incorporated by reference.

### FIELD OF INVENTION

This invention relates to a barrier to prevent flood water intrusion into a structure. More specifically, the present invention provides a portable barrier gate to seal openings in a structure to prevent flood water intrusion.

### BACKGROUND OF THE INVENTION

Homes and buildings located in flood-prone areas may be subject to occasional inundation with water during flood periods. The National Oceanic and Atmospheric Administration estimates that flood damage has resulted in around $8.2 billion from 2013 through 2023. Even small flooding in a residential structure, such as a single inch of flood water in a 2,500 square foot home, can result in about $25,000 in damage, according to the Federal Emergency Management Agency.

In order to minimize the damage and inconvenience from such occasions, devices have been suggested for removable installation in structure openings located at or below expected flood levels. When installed, such barriers prevent or substantially minimize ingress of flood waters within the height limits of the barrier panels. Examples of such barriers are seen in Smith (U.S. Pat. No. 7,523,589), disclosing a frame with scissor jacks to extend the sides and covered with a metal panel, Petty (GB Pat. 2,114,197), disclosing a hinged frame installed in a bag of extensible material, such that depressing the activator mechanism extends the sides laterally to lock the frame in the doorway or window.

Buss (DE Pat. 4,023,286) discloses a barrier formed of a frame that is mounted into the base of an opening and comprises threaded supports to press a seal against the soffit of the opening. Harrison (U.S. Pat. No. 6,427,396) and Russell (U.S. Pat. No. 5,943,832) each discloses a scissor jack allowing for lateral sliding of support members to fit a or door frame and includes a front panel cover to access to the scissor adjusting mechanism.

Other attempts for more permanent flood water barriers generally require permanent fitments, such as channels or anchor wells, disposed in the doorway for receiving a gate or panel, such as Iskra (GB Pat. 2,114,199) and Lawrence (GB Pat. 2,254,639). However, permanent channels and anchor wells are subject to wear from vehicles and weather, and can damage the fitment thereby reducing sealing and allowing for potential water intrusion. Further, permanent fitments can be unsightly, and can damage the opening since the channel or anchor well requires drilling into the opening's frame, base, or structure's slab. This compromises the stability of the structure, from minor reductions in structure results in deterioration in structural integrity or serious damage to the structural walls.

As such, an unmet need exists in the art for a watertight barrier of a building that can resist significant hydrodynamic forces while concurrently not compromising the structural integrity of the building.

### SUMMARY OF THE INVENTION

The invention provides for a watertight barrier, comprising at least one extendable anchor and at least one flood gate. The anchor member is formed of aluminum, stainless steel, surgical steel, plastics. Useful aluminums include alloys, such as 2024, 6061, and 7075 aluminum. Plastics can include nylon, polyphenylene sulfide, polyetheretherketone, polyetherimide, polyamideimide, or fiber-reinforced plastics, such as carbon fiber, fiberglass, or aramid fiber in a matrix. Useful matrixes include, but are not limited to, epoxy, vinyl ester, and polyester.

The one or more flood gates include a gate main panel with a silicone seal disposed at least on the bottom edge of the gate main panel. Where the gate main panel is used without an extendable gate panel, the silicone seal is disposed around the bottom edge and the vertical edges, either as a single seal or as multiple seals, each disposed on an edge of the gate main panel. Where the gate main panel is used with one extendable gate panel, the silicone seal is disposed around the bottom edge and the vertical edge opposite the extendable gate panel. Where gate main panel is used with two extendable gate panels, the silicone seal is disposed around the bottom edge only. The extendable gate panel is slidingly connected to the gate main panel and includes a silicone seal along the bottom and outer edge of the extendable gate panel, or a silicone seal is disposed on the bottom edge and a second seal is disposed on the outer edge of the extendable gate panel. An extension panel seal is disposed on the outer face of the gate main panel or the interior face of the extendable gate panel, such that the extension panel seal fits between the gate main panel and the extendable gate panel. The interior of the gate main panel optionally includes cross beam supports, foam insulation, or spray insulation. In other variations of the invention, the flood gates include a gate main panel and at least one extendable panel. The main gate and at least one extendable panel include at least one silicone seal on the bottom edge of the panel that acts as a lower silicone seal that provides a water-tight seal on the lower edge of the flood gate. The main gate panel further includes a gate seal on its first vertical edge, allowing the main gate panel to form a watertight seal with the at least one extendable panel, while concurrently permitted the at least one extendable panel to slide from a retracted position to an extended position. Main gate panel includes a silicone seal on the second vertical edge to engage the building structure, where one extendable panel is used, or a second gate seal where a second extendable panel is used. If the gate uses only one extendable panel, the silicon seal on the second vertical edge is either integrated with the lower silicone seal or a separate silicone seal disposed on the second vertical edge. The at least one extendable gate panel further includes a first panel seal disposed on a first vertical edge of the at least one extendable gate panel to engage the building structure. Where two extendable gate panels are used, the second extendable gate panel includes a second panel seal disposed on a second vertical edge of the second extendable gate panel to engage the building structure. The gate further includes an extension mechanism disposed in the gate main panel and adapted to extend the at least one extendable gate panel, or extend both the first and second extendable gate panels, where present.

The panels are optionally made of aluminum, stainless steel, surgical steel, carbon fiber, plastic. Specific variations are similar to those materials disclosed for the anchors. However, as the panels require less strength compared to the anchors, additional materials can be used. Additional examples include acrylonitrile butadiene styrene (ABS), high impact polystyrene (HIPS), acrylic (PMMA), cellulose acetate, cyclic olefin copolymer (COC), ethylene-vinyl acetate (EVA), ethylene vinyl alcohol (EVOH), polyvinylfluoride (PVF), polyvinylidene fluoride (PVDF), polytetrafluoroethylene (PTFE), polychlorotrifluoroethylene (PCTFE), fluorinated ethylene-propylene (FEP), perfluoroalkoxy polymer (PFA), polyethylenechlorotrifluoroethylene (ECTFE), polyethylenetetrafluoroethylene (ETFE), perfluoropolyether (PCPE), acrylic/PVC polymer, aromatic polyester polymers (liquid crystal polymer), polyoxymethylene (acetal), polyamide (PA, nylon), polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxyalkanoate (PHA), polyketone (PK), polyester, polyethylene (PE), polyetheretherketone (PEEK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN).

### BRIEF DESCRIPTION OF THE DRAWINGS

For a fuller understanding of the invention, reference should be made to the following detailed description, taken in connection with the accompanying drawings, in which:

FIG. 1 is an illustration of a first embodiment of the invention implemented on a garage opening.

FIG. 2 is an illustration of a first embodiment of the anchor.

FIG. 3 is an illustration of a first embodiment of the gate interface.

FIG. 4 is an illustration of a first embodiment of a flood gate.

FIG. 5 is an illustration of a second embodiment of a flood gate, cross section.

FIG. 6 is an illustration of a second embodiment of the invention implemented on a garage opening.

FIG. 7 is an illustration of a third embodiment of the invention implemented on a garage opening.

FIG. 8a is an illustration of a fourth embodiment of the invention implemented on a door opening.

FIG. 8b is an illustration of a fifth embodiment of the invention implemented on a door opening.

FIG. 9a is an illustration of another embodiment of the anchor.

FIG. 9b is an illustration of another embodiment of the anchor, seen in side view.

FIG. 10 is an isometric, exploded illustration of a second embodiment of the flood gate.

FIG. 11 is an isometric illustration of a second embodiment of the flood gate.

FIG. 12 is an isometric illustration of a second embodiment of the flood gate, seen by the back view.

### DETAILED DESCRIPTION OF THE PREFERRED EMBODIMENT

As used herein, the singular forms “a,” “an” and “the” include plural referents unless the context clearly dictates otherwise. Thus, for example, reference to “a polypeptide” includes a mixture of two or more polypeptides and the like.

As used herein, “about” means approximately or nearly and in the context of a numerical value or range set forth means ±15% of the numerical.

### Example 1

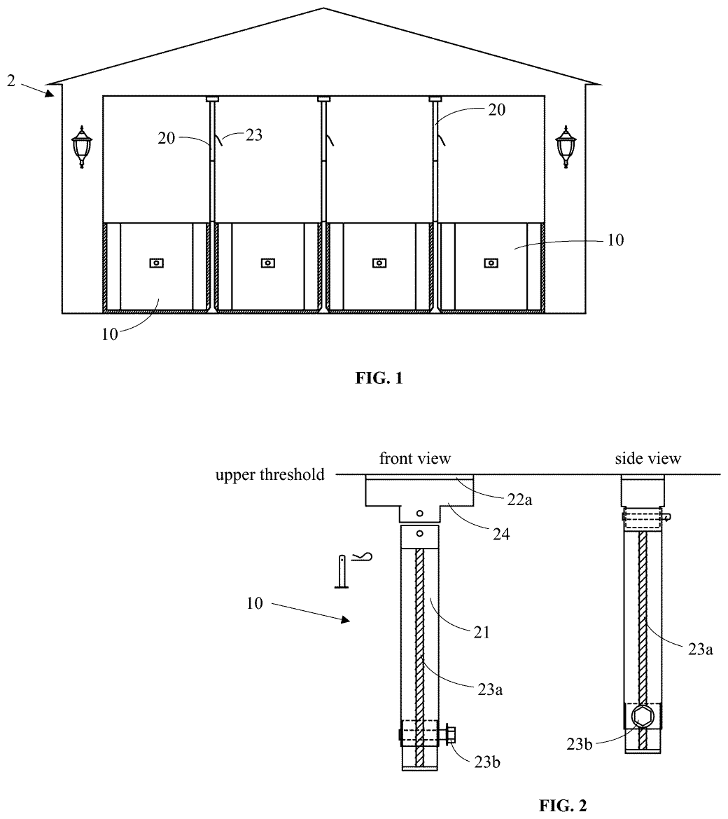

The portable barrier gate of the present invention consists of flood gate 10 and extendable anchor 20. In a preferred embodiment, flood gate 10 is extendable, thereby allowing the flood gate to fit snugly into a structure opening. Where the structure opening has large dimensions, such as a garage door opening, the portable barrier gate can use more than one flood gate 10 to provide a watertight seal on the opening. As seen in FIG. 1, the portable barrier gate system is affixed to a garage door opening using multiple extendable flood gates 10 and multiple extendable anchors 20.

In the illustrated example, extendable anchor 20 is formed of upper anchor member 21a with integrated jack 23, gate interface 26, and lower anchor member 21b with base seal 22, which is optionally silicone. In some variations, extendable anchor 20 or upper anchor member 21a includes anchor interface plate 24, having a larger cross-sectional surface area compared to upper anchor member 21a, and upper base seal 22a, as seen in FIG. 2. Extendable anchor 20 is assembled, with gate interface 26 attached to lower anchor member 21b, and upper anchor member 21a attached to lower anchor member 21b. The anchor is placed into the threshold of the garage opening.

Extendable anchor 20 can be a formed from rectangular hollow structural section (HSS) beam, an I-beam, or T beam. Optional materials for the extendable anchor are aluminum, stainless steel, surgical steel, carbon fiber, or plastic capable of withstanding compressive forces.

Optionally, upper anchor member 21a and lower anchor member 21b each include anchor member fixation aperture 28 that correspond to one another such that when upper anchor member 21a is connected to lower anchor member 21b, the corresponding anchor member fixation apertures align. A pin is inserted into anchor member fixation aperture 28, locking upper anchor member 21a to lower anchor member 21b.

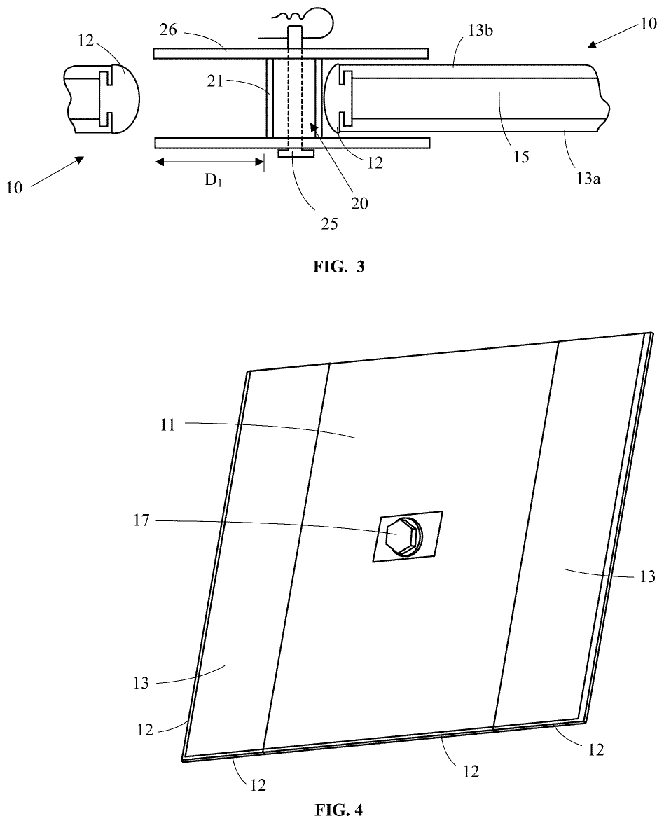

In certain embodiments, gate interface 26 has an H-shaped cross section, forming a channel on either side of the interface, seen in FIG. 3. The gate interface is optionally fixed to extendable anchor 20 using interface mount 25, such as a pin, preventing movement of the gate interface. Alternatively, gate interface 26 can be fused to the extendable anchor 20, such as be welding.

Extendable anchor 20 is extended to fit within the upper threshold and lower threshold of the opening using jack 23, such as a lever-style jack. However, the exemplary jack is a screw-style jacking system with a worm or screw drive 23a, with a rotational activator, 23b, shown in FIG. 2. Ideally, the activator can have a hex bolt interface, permitting a use to extend the anchor using a power tool or ratchet.

Flood gate 10 is comprised of a gate main panel and at least one silicone seal. The gate main panel is formed of a water impermeable material, such as aluminum, stainless steel, surgical steel, carbon fiber, or plastic. The least one silicone seal runs along the bottom edge of the gate main panel. If the flood gate is not extendable, the least one silicone seal also runs along the vertical edges of the gate main panel.

Flood gate 10 is placed into a channel in gate interface 26, as seen in FIG. 3, with silicone seal 12 aligning with at least one interior face of gate interface 26. Extendable anchor 20 is then tightened into the threshold.

Where flood gate 10 is extendable, flood gate 10 comprises gate main panel 11 and one or more extendable gate panel 13 that are slidingly fixed to gate main panel 11, as seen in FIG. 4. Notably, gate main panel 11 and one or more extendable gate panel 13 are made of a water impermeable material, such as aluminum, stainless steel, surgical steel, carbon fiber, or plastic. Gate main core 15 optionally fills an interior space formed by an interior panel 11a the gate main panel and an exterior panel 11b of gate main panel 11. Gate extension aperture 19 is disposed in gate main core 15 in instances where the core material fills all or substantially all the interior space, such as through use of spray foam or insulation. Gate extension interface 17 is connected to gate extender 18 (not shown). Gate extension interface is optionally a 15 mm socket, and is optionally connected to a screw-style or worm gear jack gate extender.

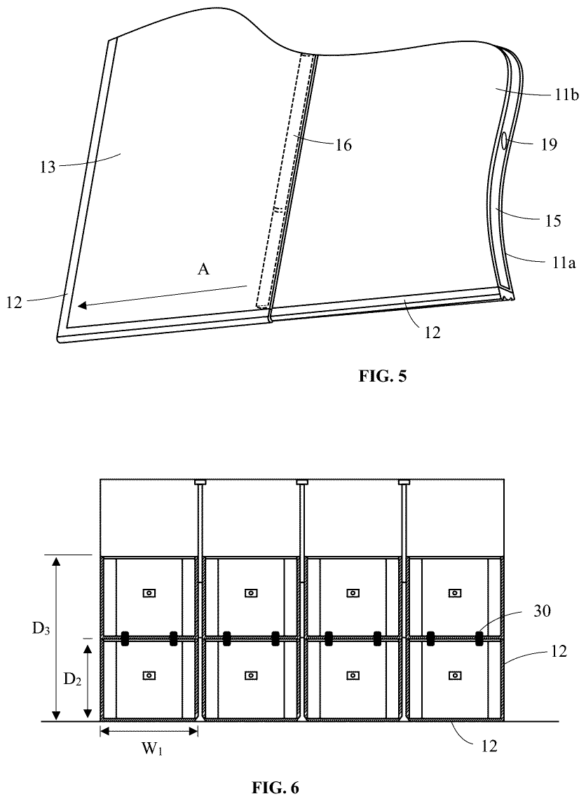

Silicone seal 12 is disposed on the outermost edge of extendable gate panel 13 and bottom edge of extendable gate panel 13. The seal can be a single flat or rounded seal, or can include numerous baffles, as seen in FIG. 5. Similarly, silicone seal 12 is disposed on the bottom edge of gate main panel 11, but not on the vertical edges of gate main panel 11 in this embodiment. Silicone extension seal 16 is affixed between gate main panel 11 and extendable gate panel 13, as seen in FIG. 5.

In certain embodiments, extendable gate panel 13 is connected to a screw-style jack in flood gate 10, allowing extendable gate panel 13 to extend from a first position to a second position, whereby a lateral portion of silicon seal 12 is pressed against gate interface 26 or extendable anchor 20, forming a watertight seal between the flood gate and extendable anchor, shown in FIG. 3. The overlap between gate interface 26 and flood gate 10 is distance D₁. Notably, gate interface 26 can have an “H” shaped cross section, as seen in the image. In specific variations of gate interface 26, distance D₁ is 2 inches.

In specific variations of the invention, extendable anchor 20 is powder-coated aluminum. Likewise, gate interface 26 is optionally powder-coated aluminum.

Additional gates can be assembled as outlines above, to form a watertight gate between the lower threshold of the garage opening and the environment, as shown in FIG. 1.

### Example 2

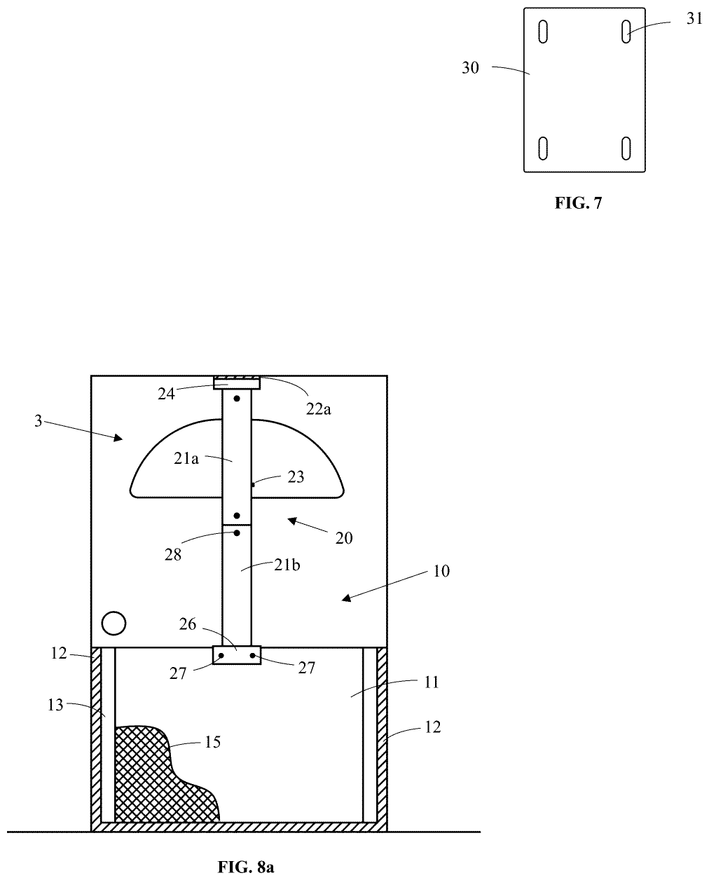

In this embodiment of the portable barrier gate, the extendable anchor and flood gates are assembled as discussed in Example 1. However, in this embodiment, additional tiers of flood gates are added to the first tier, as seen in FIG. 6. In this variation, gate interface 26 is about twice as long as in Example 1, or a second set of gate interfaces are added to extendable anchor 20, either affixing to the upper face of lower anchor member 21b or to upper anchor member 21a. The first tier of flood gates are assembled to the barrier gate. Strap tie 35 is connected to the upper edge of each flood gate 10, as seen in FIG. 6. The second tier of flood gates are assembled on the first tier, using strap tie 35 to connect the first tier to the second tier. Further, strap tie 35 ensures silicone seal 12 on the second tier pressed on the upper edge of the first tier flood gates, thereby forming a watertight seal between the first tier and the second tier of flood gates. This permits users an additional protection from flood waters, and reduces potential water intrusion from rain and storm water, as shown in FIG. 7.

In certain embodiments extendable gate panel 13 is connected to a screw-style jack in flood gate 10, as noted previously, allowing extendable gate panel 13 to travel distance to accommodate width W₁. In specific variations, W₁ is adjustable from 28-42 inches. Furthermore, stacking tiers of flood gates allows a user to increase water intrusion protection, from distance D₂, to distance D₃ (or more with additional tiers). In specific variations of the invention, distance D₂ is 32 inches, and distance D₃ is 64 inches.

### Example 3

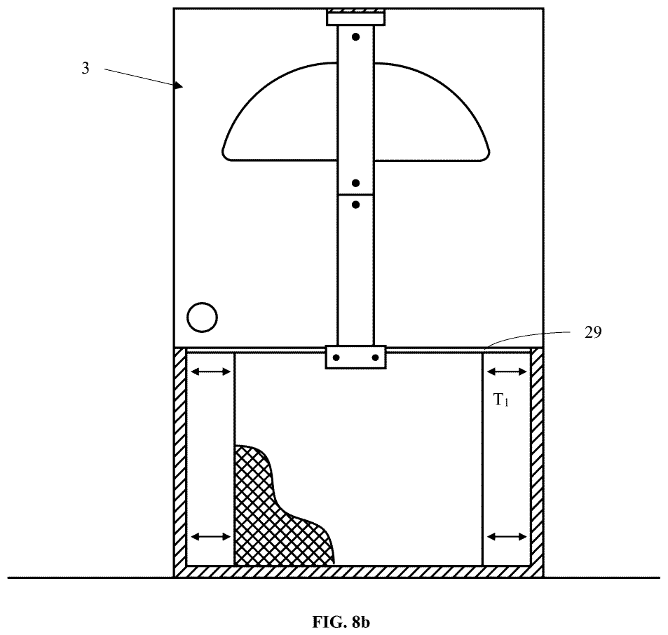

In this embodiment of the portable barrier gate is designed to form a watertight barrier for a small to medium-sized opening in the structure, such as a door or window opening. As seen in FIG. 8a, the portable barrier gate system is affixed to a door opening using a single extendable flood gate 10 and single extendable anchor 20.

In the illustrated example, extendable anchor 20 is formed of upper anchor member 21a with integrated jack 23, gate interface 26, and lower anchor member 21b with base seal 22. In some variations, extendable anchor 20 or upper anchor member 21a includes anchor interface plate 24, having a larger cross-sectional surface area compared to upper anchor member 21a, and upper base seal 22a. Extendable anchor 20 is assembled, with gate interface 26 attached to lower anchor member 21b, and upper anchor member 21a attached to lower anchor member 21b. The anchor is placed into the threshold of the door opening.

Extendable anchor 20 is extended to fit loosely within the upper threshold and lower threshold of structure opening 3 using jack 23. The exemplary jack is a screw-style jacking system having a rotational activator, shown in FIG. 2, as described in Example 1. However, in windows, the extendable anchor may not be required.

The upper edge of flood gate 10 is placed onto gate interface 26, and bolts or pins placed onto gate interface aperture 27. The bolt or pin prevents movement of the flood gate.

Where flood gate 10 is extendable, flood gate 10 comprises gate main panel 11 and one or more extendable gate panel 13 that are slidingly fixed to gate main panel 11, as described in Example 1. The flood gate components consist of corrosion-free materials, such as aluminum, plastic, carbon fiber, resin-infused composites, and other lightweight materials. Extendable gate panel 13 is extended from a first position to a second position, whereby pressing the lateral portion of silicon seal 12 against the door threshold and forming a watertight seal between the flood gate and the door jamb. Optionally, a connector pole is used to connect and upper anchor member 21a and lower anchor member 21b. The connector pole can be attached to the anchor members using anchor member fixation aperture 28, and bolts or pins placed into the apertures to fix the anchor members to the connector pole.

In other variations, anchor interface 29 is disposed on the upper edge of flood gate 10, as seen in FIG. 8b. anchor interface 29 is optionally a U-shaped angular channel fitting over the upper edge of gate main panel 11 or fitting over gate main panel 11 and extendable gate panel 13. User interface 42, such as a 15 mm socket chuck (not shown in image) is disposed on the interior face of gate main panel 11, similar to the user interface discussed in Example 5. Rotating the chuck results in extendable gate panel 13 moving along path T₁, thereby extending flood gate 10 to fit the threshold of structure opening 3.

### Example 4

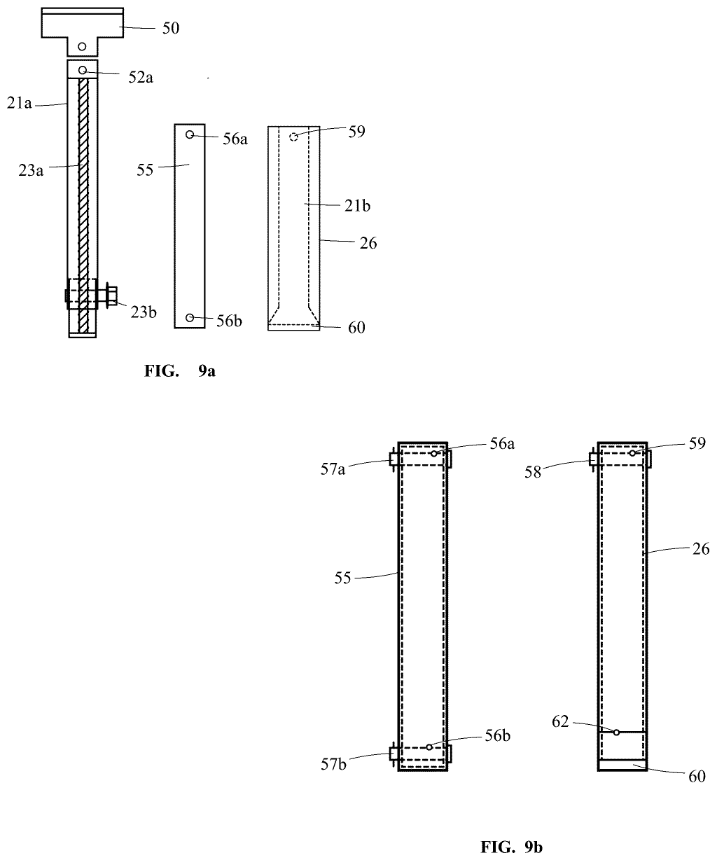

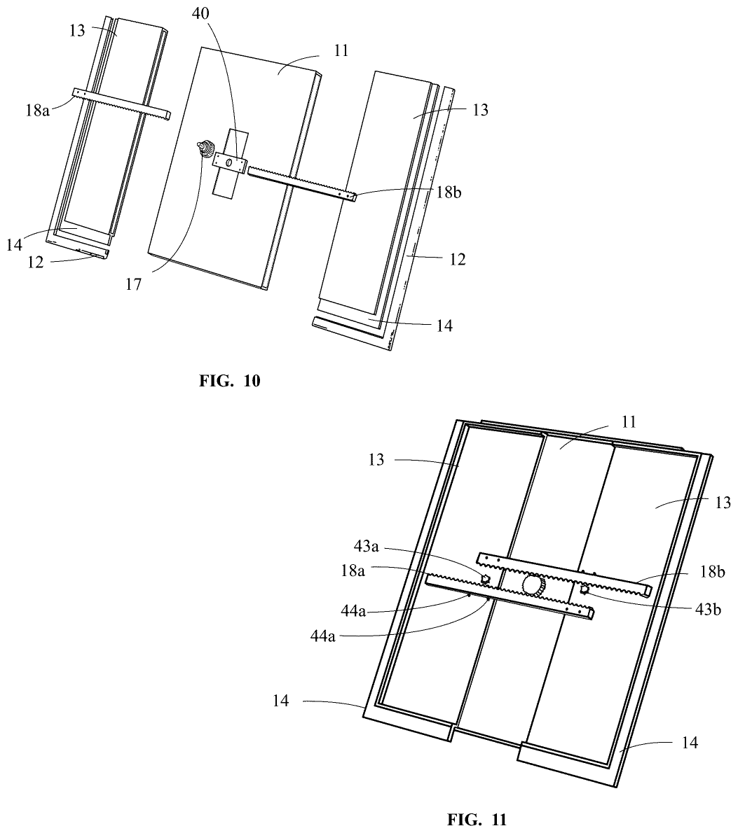

In an alternative embodiment of extendable anchor 20, upper anchor member 21a includes integrated jack 23, notably worm or screw drive 23a, with a rotational activator, 23b, as seen in FIG. 9a. In specific variations, upper anchor member 21a connects to header adapter 50, having a silicone pad, though the header adapter can be integrated into the upper anchor member. Where upper anchor member 21a is a separate element, upper header connector 52a is disposed on the upper section of upper anchor member 21a. Upper header connector 52a is shown as a aperture where a pin is inserted to link upper anchor member 21a with header adapter 50. Anchor extension member 55 includes upper anchor member connector 56a and lower anchor member connector 56b. The system can use multiple anchor extension members 55, where needed for the structure opening. Lower anchor member 21b includes upper base anchor connector 59 and gate interface 26.

In specific variations, the lower face of lower anchor member 21b includes base flare 62, which expands the member out at a 22-degree angle to permit silicone seal 12 to more easily engage the structure opening and anchor, as seen in FIG. 9b. Base 60 is disposed on the lower face of lower anchor member 21b, and is optionally formed of silicone seal.

Gate interface 26 is optionally an “H”-shaped channel formed of ¼ inch thick aluminum or carbon fiber.

### Example 5

In this embodiment of the portable barrier gate, flood gate 10 is formed of main panel 11 and one or two extendable gate panel(s) 13. In these embodiments, extendable gate panel 13 includes flange 14 on the outermost vertical edge and lower horizontal edge, as seen in FIG. 10. Flange 14 is dimensioned to accept silicone seal 12. Main panel 11 incorporates gate extension interface 17, such as gear pinion 39, approximately centrally disposed in the panel. Pinion mount 40 includes an aperture for gear pinion 39 and mounting locations, allowing pinion mount 40 to connect to main panel 11. In this embodiment, gate extender 18 is form of rail 18a and rail 18b, which are slidingly connected to main panel 11 and a rack on rail 18a, as well as 18b, interface with gear pinion 39, such that when gear pinion rotates, rail 18a and rail 18b slide along a horizontal plane. In some embodiments, extendable gate panels 13a and 13b each include core 41 with gate extension aperture 19, such as a channel. Core 41 is optionally foam. In other embodiments, rail 18a and rail 18b are mounted to extension panel 13, via a plurality of pins or wheels, as seen in FIG. 11. In this embodiment, toothed mounting wheel 43a, and where two extendable gate panels are used, toothed mounting wheel 43b is rotatably mounted to extendable gate panel 13 above rail 18a and adjacent to the rack on rail 18a. Where toothed mounting wheel 43b is also used, toothed mounting wheel 43b is rotatably mounted to extendable gate panel 13 below rail 18b and adjacent to the rack on rail 18b. Mounting pins 44a are disposed opposite toothed mounting wheel 43a, and oriented to fix rail 18a on a horizontal path of travel, as seen in FIG. 11. It is noted that while silicone seal 12 is not depicted in this image, the seal is present in the embodiment.

In specific variations, main panel 11 is 1.5 inch thick, and formed of aluminum, carbon fiber, or other composite. Main panel 11 is optionally 32 inches high and 24 inches wide, with a material thickness of 0.47 inches, and a 0.24 inch channel on bottom edge to accommodate extendable gate panel 13. Extendable gate panel 13 is, in specific embodiments, 0.31 inches thick, with a height of 32 inches and width of 7 to 10 inches. However, the width of extendable gate panel 13 may vary based on the needs of the structure opening. Silicone seal 12 is optionally a single piece 28 inch long, 32.8 inch high, 2 inch width, measured from the flange, and 1.5 inches wide, with a 0.5 inch channel to accept flange 14.

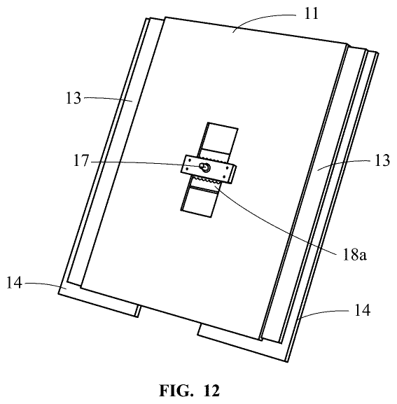

Gear pinion 39 includes user interface 42, such as a chuck. User interface 42 extends through interface aperture 43 in main panel 11, and provides user access to the extension system, as seen in FIG. 12. In certain embodiments, user interface is a chuck, and a user connects a power tool to the chuck. Upon activation of the power tool, gear pinion 39 rotates, moving rail 18a and rail 18b along its path, thereby moving extendable gate panel 13.

In specific variations, gear pinion 39 has a 1 inch long and 0.5 inch rounded polygonal chuck, whereby the gear pinion engages rail 18 that is 20 inch long and 0.675 inch wide. Pinion mount 40 is optionally 0.5 inches wide, 2 inches high.

In the preceding specification, all documents, acts, or information disclosed does not constitute an admission that the document, act, or information of any combination thereof was publicly available, known to the public, part of the general knowledge in the art, or was known to be relevant to solve any problem at the time of priority.

The disclosures of all publications cited above are expressly incorporated herein by reference, each in its entirety, to the same extent as if each were incorporated by reference individually.

While there has been described and illustrated specific embodiments of the barrier gate, it will be apparent to those skilled in the art that variations and modifications are possible without deviating from the broad spirit and principle of the present invention. It is also to be understood that the following claims are intended to cover all of the generic and specific features of the invention herein described, and all statements of the scope of the invention which, as a matter of language, might be said to fall therebetween.

What is claimed is:

1. A watertight barrier, comprising:
at least one extendable anchor, further comprising:
at least one anchor member having an upper face and a lower face;
a base seal disposed on the lower face of the at least one anchor member;
a jack integrated in the at least one anchor;
a gate interface disposed on the at least one anchor member and dimensioned to accept a flood gate;
at least one flood gate, further comprising:
a gate main panel, having a face formed of a water impermeable material, an upper edge, a first vertical edge, a second vertical edge, and a bottom edge;
at least one silicone seal disposed on the bottom edge of the gate main panel;
a seal disposed on a first vertical edge of the at least one flood gate, wherein the seal is a second seal or the at least one silicone seal disposed on the gate main panel;
a seal disposed on a second vertical edge of the at least one flood gate, wherein the seal is a second seal or the at least one silicone seal disposed on the gate main panel.

2. The watertight barrier of claim 1, wherein the at least one extendable anchor further comprises:
an upper anchor member having an upper face and a lower face;
a lower anchor member disposed on the lower face of the upper anchor member, and having a lower face; and
wherein the base seal is disposed on the lower face of the lower anchor member.

3. The watertight barrier of claim 2, further comprising a jack integrated in the at least one anchor and adapted to extend the lower face of the lower anchor member from the upper anchor member; and
wherein the jack is integrated in the upper anchor member.

4. The watertight barrier of claim 2, further comprising an anchor interface plate and upper base seal;
wherein the anchor interface plate is disposed on the upper face of the upper anchor member and has an upper face;
wherein the anchor interface plate has a larger cross-sectional surface area compared to upper anchor member; and
wherein the upper base seal is disposed on the upper face of the anchor interface plate.

5. The watertight barrier of claim 1, wherein the base seal is silicone.

6. The watertight barrier of claim 2, further comprising a first anchor member fixation aperture disposed along upper anchor member and a second anchor member fixation aperture disposed along lower anchor member;
wherein the first anchor member fixation aperture corresponds to the second anchor member fixation aperture when upper anchor member is connected to lower anchor member;
wherein the first anchor member fixation aperture is removably fixed to the second anchor member fixation.

7. The watertight barrier of claim 1, wherein the gate interface has an H-shaped cross section.

8. The watertight barrier of claim 7, wherein the gate interface is removably fixed to the extendable anchor using interface mount, or fused to the extendable anchor.

9. The watertight barrier of claim 8, wherein the interface mount is a pin, or wherein the fused to the extendable anchor is welding.

10. The watertight barrier of claim 1, wherein the flood gate is extendable, wherein the extendable flood gate further comprises:
a gate main panel;
at least one extendable gate panel slidingly fixed to the gate main panel;
wherein the at least one extendable gate panel has a face formed of a water impermeable material, an upper edge, a first vertical edge, and a bottom edge;
wherein the seal disposed on a first vertical edge of the at least one flood gate is disposed on the first vertical edge of the at least one extendable gate panel;
a silicone seal disposed on the bottom edge of the at least one extendable gate panel;
an extension mechanism disposed in the gate main panel and adapted to extend the at least one extendable gate panel.

11. The watertight barrier of claim 10, wherein the extendable flood gate further comprises a silicone extension seal disposed between the gate main panel and the at least one extendable gate panel.

12. The watertight barrier of claim 10, wherein the extension mechanism is a screw-style jack.

13. A watertight barrier, comprising:
at least one extendable anchor, further comprising:
at least one anchor member having an upper face and a lower face;
a base seal disposed on the lower face of the at least one anchor member;
a jack integrated in the at least one anchor;
a gate interface disposed on the at least one anchor member and dimensioned to accept a flood gate;
at least one flood gate, further comprising:
a gate main panel having a face formed of a water impermeable material, an upper edge, a first vertical edge, a second vertical edge, and a bottom edge;
at least one silicone seal disposed on the bottom edge of the gate main panel;
a gate seal disposed on a first vertical edge of the gate main panel, wherein the gate seal is disposed to sealingly engage a second vertical edge of an at least one extendable gate panel;
the at least one extendable gate panel slidingly disposed on the first vertical edge of the gate main panel;
wherein the at least one extendable gate panel has a face formed of a water impermeable material, an upper edge, a first vertical edge, and a bottom edge;
an extendable panel silicone seal disposed on the bottom edge of the at least one extendable gate panel;
a first panel seal disposed on a first vertical edge of the at least one extendable gate panel to engage a first structure aperture member, wherein the panel seal is a second extendable panel silicone seal or the extendable panel silicone seal disposed on the bottom edge of the at least one extendable gate panel;
a second panel seal disposed to engage a second structure aperture member; and
an extension mechanism disposed in the gate main panel and adapted to extend the at least one extendable gate panel.

14. The watertight barrier of claim 13, further comprising a second extendable gate panel slidingly disposed on the second vertical edge of the gate main panel;
a second gate seal disposed on a second vertical edge of the gate main panel, wherein the second gate seal is disposed to sealingly engage a second vertical edge of the second extendable gate panel;
wherein the second extendable gate panel has a face formed of a water impermeable material, an upper edge, a first vertical edge, and a bottom edge;
an extendable panel silicone seal disposed on the bottom edge of the second extendable gate panel;
wherein the second panel seal is disposed on a second vertical edge of the second extendable gate panel, wherein the second panel seal is a second extendable panel silicone seal or the extendable panel silicone seal disposed on the bottom edge of the second extendable gate panel; and
wherein the extension mechanism disposed in the gate main panel is adapted to extend the at least one extendable gate panel and the second extendable gate panel.

15. The watertight barrier of claim 13, wherein the extension mechanism is a screw-style jack.

16. The watertight barrier of claim 13, wherein the at least one extendable anchor further comprises:
an upper anchor member having an upper face and a lower face;
a lower anchor member disposed on the lower face of the upper anchor member, and having a lower face; and
wherein the base seal is disposed on the lower face of the lower anchor member.

17. The watertight barrier of claim 16, further comprising a jack integrated in the at least one anchor and adapted to extend the lower face of the lower anchor member from the upper anchor member; and
wherein the jack is integrated in the upper anchor member.

18. The watertight barrier of claim 16, further comprising an anchor interface plate and upper base seal;
wherein the anchor interface plate is disposed on the upper face of the upper anchor member and has an upper face;
wherein the anchor interface plate has a larger cross-sectional surface area compared to upper anchor member; and
wherein the upper base seal is disposed on the upper face of the anchor interface plate.

19. The watertight barrier of claim 13, wherein the base seal is silicone.

20. The watertight barrier of claim 13, wherein the gate interface is removably fixed to the extendable anchor using interface mount, or fused to the extendable anchor.
